(19) United States
(12) Patent Application Publication
(10) Pub. No.: US 2023/0210644 A1
(43) Pub. Date: Jul. 6, 2023

(54) DOUBLE-ENDED ORAL CARE DEVICE WITH INTERCHANGEABLE SNAP-ON FLOSSERS AND DISPOSABLE IMPLEMENTS

(71) Applicant: Boris Kaylakov, Rego Park, NY (US)

(72) Inventor: Boris Kaylakov, Rego Park, NY (US)

(21) Appl. No.: 17/569,010

(22) Filed: Jan. 5, 2022

(51) Int. Cl. A61C 15/04; A46B 5/00; A46B 5/02; A46B 15/00; A46B 7/04

(52) U.S. Cl. CPC A61C 15/048; A46B 5/0012; A46B 5/0095; A46B 5/023; A46B 5/025; A46B 5/026; A46B 15/0073; A46B 7/042; A46B 15/0075; A46B 2200/108; A46B 2200/1026

(57) ABSTRACT

A multiple purpose oral care device is provided. The device comprises a two-ended manual tool with ergonomically shaped handle and attachment components located at least at a first end to accommodate semi-circular snap-on flossers. The device also comprises disposable implements for dental and gum care that attach to the snap-on flossers and comprise optional structures. The disposable implements comprise at least one of brushes and gum stimulators and are situated at ends of the snap-on flossers. A first optional structure combines a snap-on flosser and two parallel inter-proximal brushes, one on each end of the flosser. The first optional structure is directed to orthodontic patients with braces and patients with fixed restorations comprising at least one of crowns and bridges. A second optional structure comprises two gum stimulators, one with each attached on opposite sides of the snap-on flosser, pointing inward to each other and parallel to floss.

### FIELD OF THE INVENTION

The present disclosure is in the field of oral care. More particularly, the present disclosure provides systems and methods of an ergonomically shaped handheld tool that accommodate various fittings at either end, or both ends simultaneously, for dental and gum care including brushes, flossers, and gum stimulators that perform multiple oral hygiene functions quickly, effectively, and safely.

### BACKGROUND

Removal of dental plaque by oral hygiene appliances should be performed daily. A common toothbrush is used to remove food debris and bacteria from surfaces of teeth. Dentists recommend brushing twice a day (morning and night). It is also recommended by dental professionals to floss at least once a day, preferably after meals.

Snap-on flosser is an existing device. It is composed of a threaded instrument with a handle that is used to remove food particles and bacteria between adjacent teeth. Disposable flosser refills and easy design makes the snap-on flosser useful for patients with poor hand-to-eye coordination or arthritis and for handicapped individuals.

Inter-proximal brushes (proxy brushes or interdental brushes) are used by patients who have gaps between teeth and especially by those with orthodontic appliances. Patients with braces cannot floss since wire prevents floss from getting between the two teeth. Also, patients with fixed dental work such as crowns and bridges may prefer inter-proximal brushes since such brushes can reach under bridges and crowns and clean debris more effectively than other devices.

A common misconception is that interproximal brush should substitute a regular floss. However, a regular floss effectively cleans the contact area or contact point between two adjacent teeth. Inter-proximal brushes, on the other hand, clean the embrasure between two teeth just under the contact point. Floss cleans the contact between two teeth while proxy brush the embrasure just below (apical) that contact. Orthodontic braces are one of appliances where inter-proximal brush substitutes for dental floss, simply because floss cannot get below the wire physically.

Gum stimulator is a dental device with rubber in a form of small bulb with tapered tip. Rubber tips can come in various disposable refills. This device is used to stimulate gingival blood flow interdentally, more specifically papilla area of adjacent teeth.

### BRIEF DESCRIPTION OF THE FIGURES

Although the device of the present disclosure is double ended and accommodates attachments at one or the other end or both ends simultaneously, each of FIG. 1 through FIG. 7 depict the device with only a single attachment at one end while the second end is empty. Since the second end has no attachments in FIG. 1 through FIG. 7, the second end is not shown in those figures. FIG. 8 and FIG. 9 depict the device as double ended with attachments at each end simultaneously. Thus, the device of the present disclosure may be used as single- or double-ended at the user's option.

FIG. 1 is an image of a double ended handle (FIG. 1 is showing one end) and attachment comprising a dental floss on one end with two parallel small interdental brushes on each side of dental flosser. The attachment may be directed to users with fixed restorations such as crowns and bridges.

FIG. 2 is an image of a snap-on flosser and gum stimulator comprising a double ended handle and dental floss on one end with two gum stimulators attached on each side of floss running to each other and parallel to floss. The attachment may be directed to flossing teeth and stimulating blood flow to interdental gingival areas, enabling simultaneous flossing and gum stimulation.

FIG. 3 is an image of an attachment comprising a combination of floss, proxy brush and gum stimulator with each end of floss containing both proxy brush and gum stimulator and rendering it possible to simultaneously floss, brush between teeth, and stimulate gums.

FIG. 4 is an image of a double ended handle with attachment containing two dental flosses parallel to each other and extending from one side of the flosser to the other. The attachment useful to floss upper and lower teeth at the same time by placing flosser between two adjacent teeth and slightly closing mouth.

FIG. 5 is an image of a double ended handle with attachment containing two gum stimulators running toward each other. The attachment directed toward massaging all interdental papillae faster than a regular gum stimulator and with an ergonomic design enabling it to stimulate blood flow on buccal as well as on lingual of each papilla between adjacent teeth.

FIG. 6 is an image of double ended handle and two interdental brushes that run parallel to each other. The attachment useful in cleaning all inter-proximal areas as well as under crowns, bridges, and orthodontic wires.

FIG. 7 is an image of double ended handle that contains proxy brush and gum stimulator on both sides of flosser. The attachment useful for patients with braces and fixed restorations including crowns, bridges and especially roundhouse bridges.

FIG. 8 is an image of a double ended handle with a combination of floss, proxy brush and gum stimulator in accordance with an embodiment of the present disclosure. Please note here two ends have attachments unlike FIGS. 1-7, wherein only one end had a specific attachment.

FIG. 9 is an image of a double ended handle with two attachments including floss, proxy brush and gum stimulator in accordance with an embodiment of the present disclosure.

FIG. 10 is an image of a double ended handle with indentations on each end for two different attachments in accordance with an embodiment of the present disclosure.

### DETAILED DESCRIPTION

Systems and methods described herein provide an elongated, double-ended manual device for oral care that combines three tools of floss, brush, and gum stimulator into one. Each of the two ends of the tool contains slots, indentations, or fittings that permit interchangeable attachment of snap-on flossers that are semi-circular or U-shaped.

The snap-on flosser at its center or midpoint attaches to the end tool via the slots. In most cases, dental floss is tightly strung from one prong of the flosser to the other prong of the flosser at a level slightly below the ends of the prongs. The ends of the prongs may hold implements comprising brushes and/or gum stimulators in various combinations and configurations to facilitate cleaning of teeth and gums and massaging gums.

Systems and methods described herein evidence novelty by combining interchangeable snap-on flossers with brushing and gum stimulation implements to provide a more efficient and advanced single device that takes less space, alleviates need to look for other devices, and can make hygiene more fun and less of a chore.

The double-ended handle allows the user to have his/her favorite type of appliance at one end and second type of appliance at the other end. But if preferable, it can be used purely as a single-ended device.

The handle of the tool may be made of plastic or similar substance and is ergonomically shaped to allow a user to comfortably manipulate either end of the tool. Both ends of the tool may simultaneously be configured hold flossers variously configured with brushes and gum stimulators. In embodiments, one end of the tool may simultaneously hold two flossers.

Combinations of implements comprising brushes and/or gum stimulators may be referred to hereinafter as optional structures as the brushes and stimulators may be positioned alone or in combination with each other on prongs of flossers. The implements may be positioned in various manners such as parallel to one another in some embodiments and pointing at one another in other embodiments.

Systems provided herein may be more compact in terms of space and can be used while traveling. They will require less dexterity and therefore can be used by very young individuals and elderly, especially those with poor coordination and arthritis. They may also save time for individuals using them since all oral hygiene care is performed at the same time instead of separately brushing, flossing, and stimulating gingival blood flow.

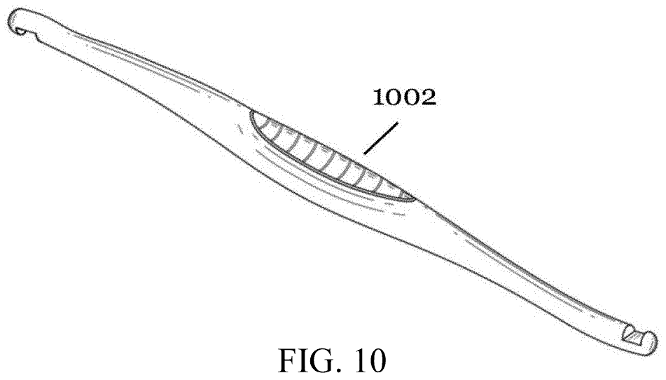

Turning to the figures, FIG. 10 depicts the tool with handle 1002 without any snap-on flossers or other attachments. Visible at each end of the tool are slots for placement of snap-on flossers as described herein

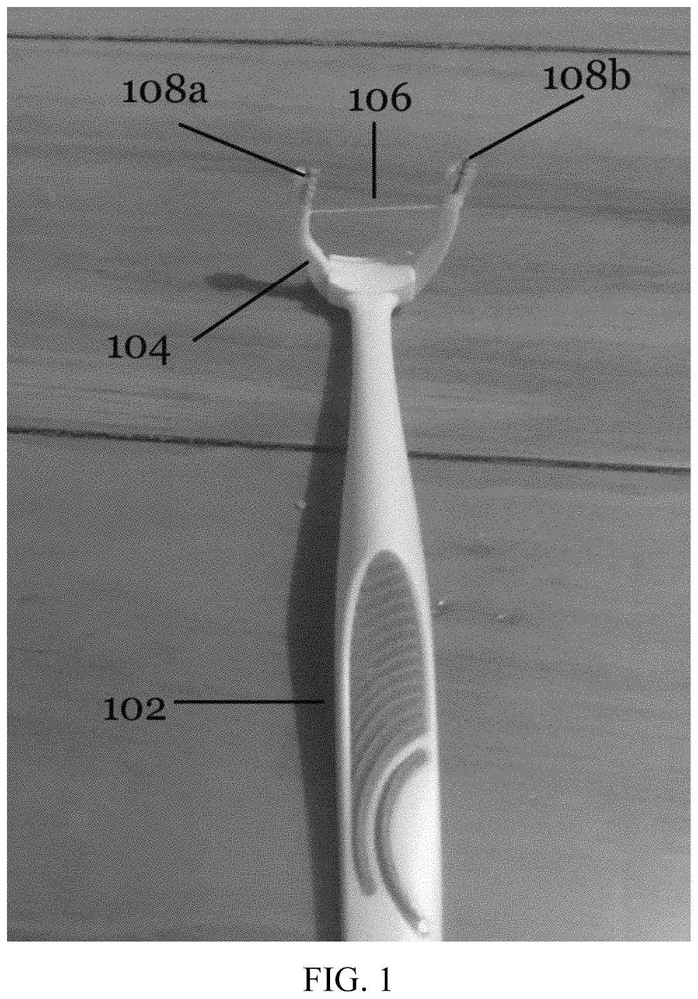

FIG. 1 is an image of a first optional structure that combines a handle 102, snap-on flosser 104 with floss 106, and an inter-dental or inter-proximal brush with two parallel inter-proximal brushes 108a-b, one on each end of the flosser 104. The first optional structure may be directed to orthodontic patients with braces and patients with fixed restorations comprising at least one of crowns and bridges.

The first optional structure in FIG. 1 may be used for many types of interdental cleaning, under crowns, bridges, braces' wires, and metal space maintainers. It may be useful device for patients with fixed restorations whether it be crown or bridge. Instead of just flossing with regular floss and brushing with interdental brush, a user may perform these two functions simultaneously.

The attachment of FIG. 1 is also more advanced than regular proxy brush because there is no need to bend it to reach back teeth and no need to bend it to reach inside between teeth. Further, it also allows for flossing.

To use the attachment as depicted in FIG. 1, a user may follow these instructions: 1) gently place pressure on the handle with floss between the adjacent teeth, with small seesaw motion get below the tight spot (contact area); 2) hug one tooth and move floss up and down slightly under gum; 3) hug the other tooth and move floss up and down slightly under gum as well; 4) remove floss from between two teeth; and 5) use both inter-proximal brushes simultaneously to brush between two top teeth and between two lower teeth at the same time. This attachment as in FIG. 1 may be useful to clean lingual interdental spaces between teeth, because regular proxy brush is difficult to adjust so to fit into lingual embrasure.

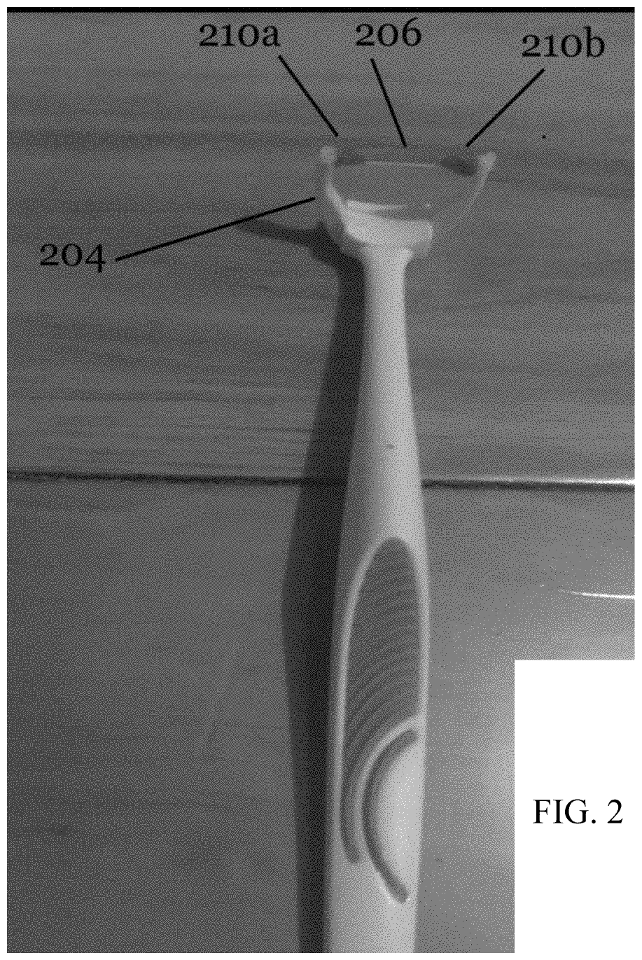

FIG. 2 is an image of a second optional structure including combination floss 206 and gum stimulator 210a-b. Components in FIG. 2 through FIG. 9 are indexed to components appearing in FIG. 1. To use this attachment user may: 1) gently place pressure on a handle with floss between the adjacent teeth, with small seesaw motion get below the tight spot (contact area); 2) hug one tooth and move floss up and down slightly under gum; 3) hug the other tooth and move floss up and down slightly under gum as well; and 4) massage papillae (gum on each side) by moving floss gently side to side.

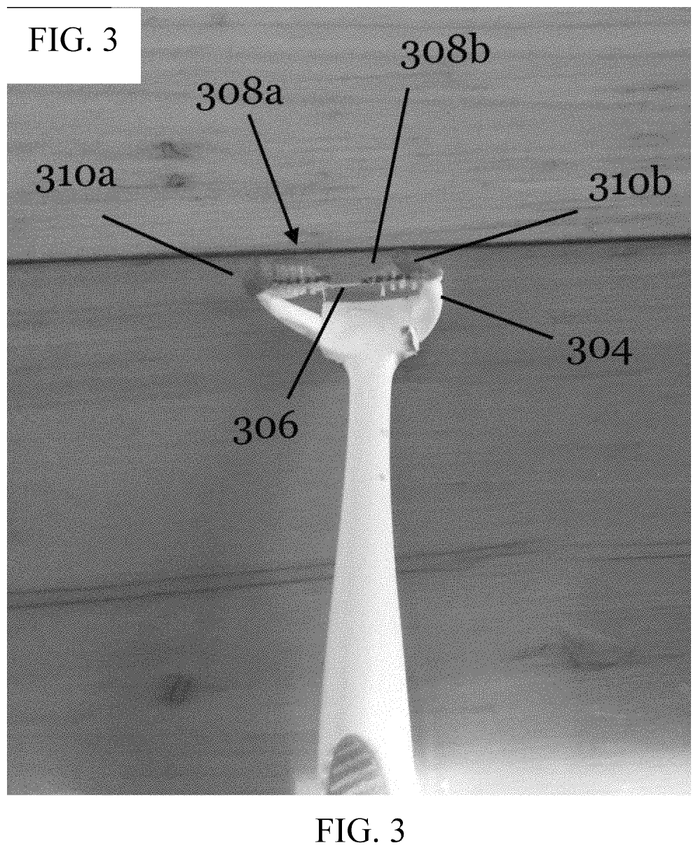

FIG. 3 is an image of third optional structure that is a composite of dental floss 306, proxy brush 308a-b and gum stimulator 310a-b, available in a single attachment. This attachment can be used by most patients but especially useful for patients with fixed restorations like fillings, crowns, and implant crowns.

To use the third optional attachment, a user should perform the following steps: 1) place floss with light pressure between adjacent teeth; 2) move slowly side to side; 3) repeat steps 1 and 2 between all teeth. This attachment will floss, brush between two teeth and stimulate gums at the same time.

Flossing plus proxy brush plus gum stimulator taken together as provided herein may also stimulate gum blood flow unlike another previous implementation referred to as InterFloss, which is just floss and proxy brush. The double-sided nature of the system provided herein is also unlike another previous implementation referred to as InterFloss which is one sided. InterFloss is a prior art combination device of floss and inter-proximal brush. Thus, this device flosses and brushes between teeth at the same time. However, the device of FIG. 3 has a retractable flosser head with inter-proximal brush and gum stimulator. Therefore, unlike InterFloss, the device of FIG. 3 also massages gums between teeth as the patient cleans with proxy brush. In other words, the attachment of FIG. 3 is a combination of what Interfloss may provide and a gum stimulator. Another difference with InterFloss is that retractable head of the present disclosure has inter-proximal brush from both sides of floss, not one side as with InterFloss. The device of FIG. 3 is therefore two-sided instead of one-sided as with InterFloss, thus it is more symmetric, functional, and easier to use.

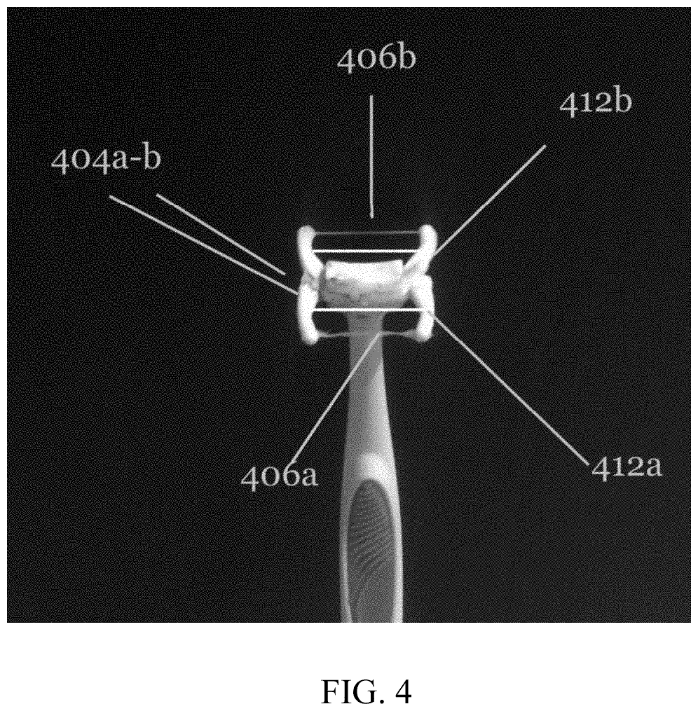

FIG. 4 depicts a fourth optional structure comprising two snap-on flossers 404a-b and floss 406a-b on one end of the handle and is directed to flossing upper and lower teeth simultaneously. This attachment can floss between two upper teeth and two lower teeth at the same time simply by mouth closing or light biting.

To use the fourth optional structure, the user would place attachment either between two upper or two lower teeth and then bite slowly. While biting, teeth will be stopped by horizontal bars 412a-b as shown in FIG. 4. The user then continues flossing by repeating the above action for all interdental spaces. Thus, flossing can be done in about half the time normally needed and requires less dexterity by the user. The fourth optional structure may be used by children, persons with arthritis, persons with other disabilities such as poor hand-to-eye coordination and handicapped patients with lack of muscle control who may rely on caregiver assistance. Also, for some users with disabilities biting can be much easier than hand and wrist manipulation that required by a typical snap on flosser with a regular floss.

Bite floss novelty arises from simultaneously flossing between two upper and lower teeth at same time.

Hands-Free Dental Flosser is prior art device similar to the retractable double-sided floss of FIG. 4. The difference is, as name implies, the Hands-Free Dental Flosser works without hands. However, the attachment of FIG. 4 flosses between two upper and two lower teeth at the same time and also contains a handle.

The Hands-Free Dental Flosser is cylindrical with many flosses, but the attachment of FIG. 4 has only two parallel flosses. The Hands-Free Dental Flosser works by using tongue, lips and cheeks to move hands-free flosser and biting the device. The attachment of FIG. 4 works by using handle on dominant hand and biting. Each bite simultaneously flosses two upper and between two lower teeth.

Another existing device similar in design to the attachment depicted by FIG. 4 is Instafloss, a Waterpik flosser. The attachment of FIG. 4 represents a manual flosser with actual floss instead of water pressure. The attachment of FIG. 4 has horizontal bars 412a-b. When patient bites, the horizontal bars 412a-b stop teeth from meeting each other and at same time two flosses floss between teeth.

Instafloss does not floss the contact point or contact area between teeth. However, the attachment of FIG. 4 does floss the contact point and contact area since it is manual flosser and includes actual floss.

Unlike hands free floss, the attachment depicted in FIG. 4 performs better flossing. In addition, the attachment depicted in FIG. 4 performs flossing unlike previous implementations referred to as Instafloss.

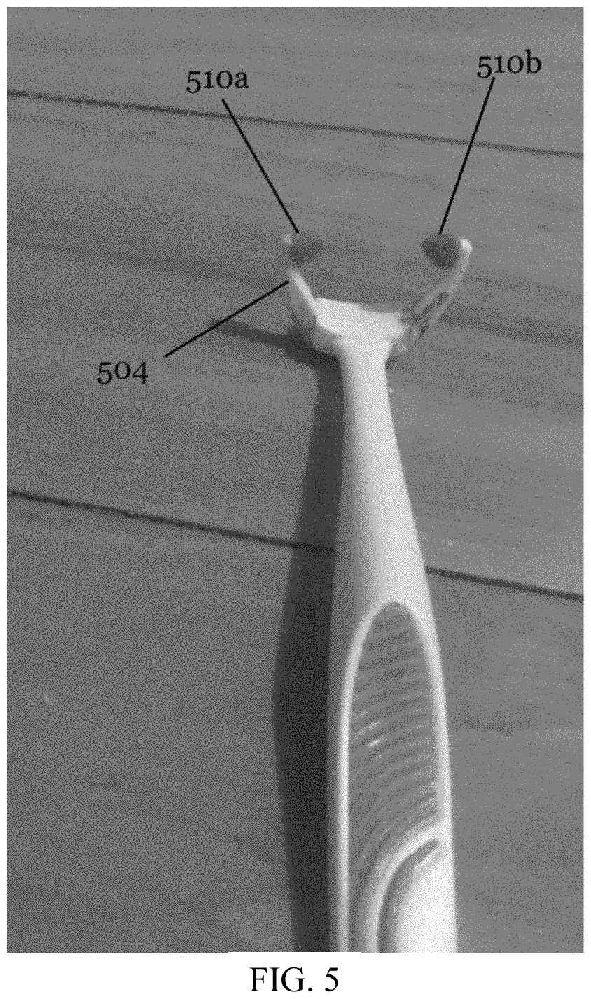

FIG. 5 depicts a fifth optional structure comprising a snap-on flosser without floss but with two gum stimulators, one on each end of the flosser and pointing toward each other. Gum stimulators are typically used in two different ways. One way is as an actual stimulator, by applying its tip into gum between teeth (interdental papilla) and using either circular motion or light pushing into gum, thus stimulating blood flow into that area between teeth. Secondly, gum stimulators may be used as cleaner under gum, inside the gingival crevice or pocket.

There is also a continuing need to stimulate blood flow between teeth on inside and outside as with proxy brushes described herein. It may be difficult to use a gum stimulator of the prior art to stimulate blood flow from inside between teeth because designs provided by previous implementations do not allow for it. However, the design of the attachment shown in FIG. 5 may allow easier use because it more readily stimulates blood flow since its U-shaped double-sided flosser allows for easier stimulation inside.

In addition, the attachment shown in FIG. 2 may be used similarly for easier stimulation of blood flow between teeth on inside but also it includes a floss. Gum stimulators shown in FIG. 2 and FIG. 5 are on both sides of flosser and it therefore may be possible to stimulate blood flow between teeth on inside and outside simultaneously. Thus, the double gum stimulator allows for stimulation of both buccal and lingual side of gums at the same time.

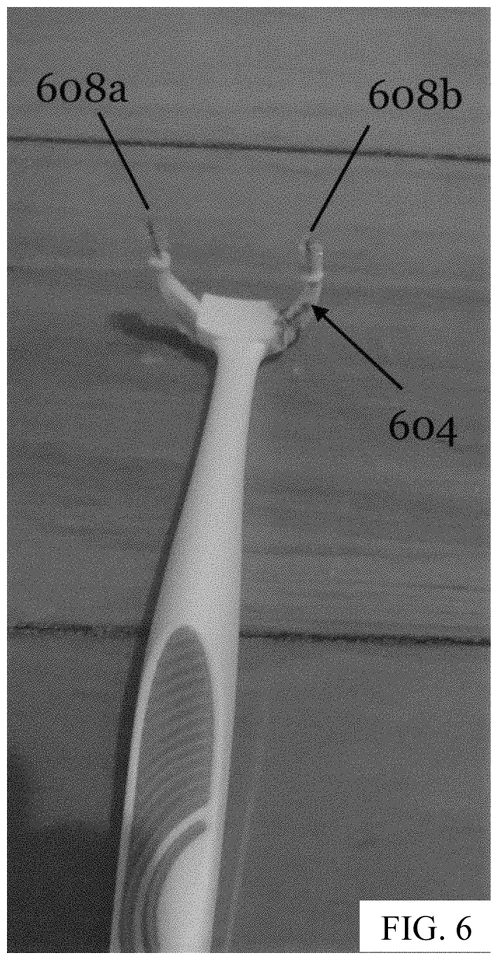

FIG. 6 depicts a sixth optional structure comprising two interproximal brushes per flosser, each positioned on ends of a flosser and parallel to each other. Instead of having one inter-proximal brush, the sixth optional structure has two, indicated as 608a-b. The sixth structure is directed to orthodontic braces and patients with round-house bridge (bridge spanning all around for all dentition). Since floss cannot be used between teeth for these patients, the sixth structure shown in FIG. 6 can be useful to clean under wire or bridge and the structure shown in FIG. 5 can be used to stimulate blood flow to gums.

To use the sixth structure that is shown in FIG. 6, the user would: 1) slightly close mouth and place device so that one proxy brush touch between two upper teeth and other proxy brush touch between two lower teeth; 2) gently massage into embrasures; 3) repeat steps 1 and 2 for all teeth; and 4) by moving handle slightly inward, perform cleaning of the lingual embrasure between all upper and lower teeth if needed.

Some observers incorrectly believe that inter-proximal brushes must be used from one side only, the outside. In reality, brushing from both: inside and outside is important. FIG. 6 illustrates two parallel proxy brushes that can be used to brush inside and outside more easily than existing proxy brushes without bending the brush. The original proxy brush needs to be bent to brush inside. Also, bending causes brush to break sooner or become less functional. The device of FIG. 6 requires no bending.

A user would just rotate and reach inside, with slight rotation again, and reach outside with brush between teeth. Also, the original proxy brush needs to be bent to reach back teeth. With the attachment of FIG. 6, there is no need to bend the brush as its shape helps to reach the back teeth with no bending. Since no bending is needed this attachment of FIG. 6 may last longer than original proxy brush. Also, it can be used to brush between two upper and lower teeth at same time.

The system provided herein is more comfortable as it does not need to flip to be applied to the other side of the user's mouth. Two parallel proxy brushes allow the device to go between upper and lower teeth at same time. But also made easier in addressing lingual side embrasures(space between teeth) because the handle allows for easier rotation.

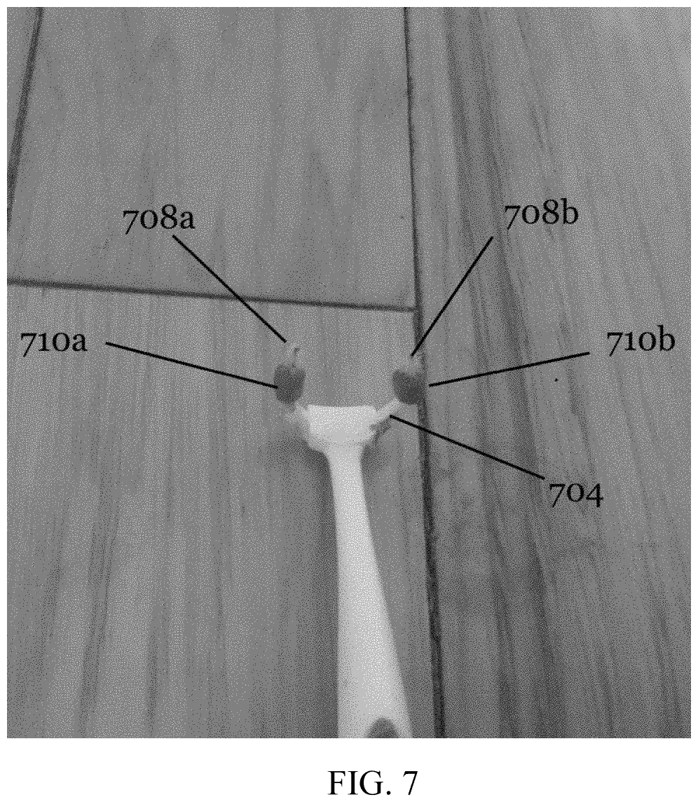

FIG. 7 depicts a seventh optional structure in which proxy brushes 708a-b and gum stimulators 710a-b are in pairs, with each pair occupying an end of the snap-on flosser 704. To use the attachment with the structure illustrated in FIG. 7, a user would 1) use it as a regular proxy brush and at the end of use lightly massage into interdental embrasure with circular motion; and 2) repeat the step 1 between all teeth.

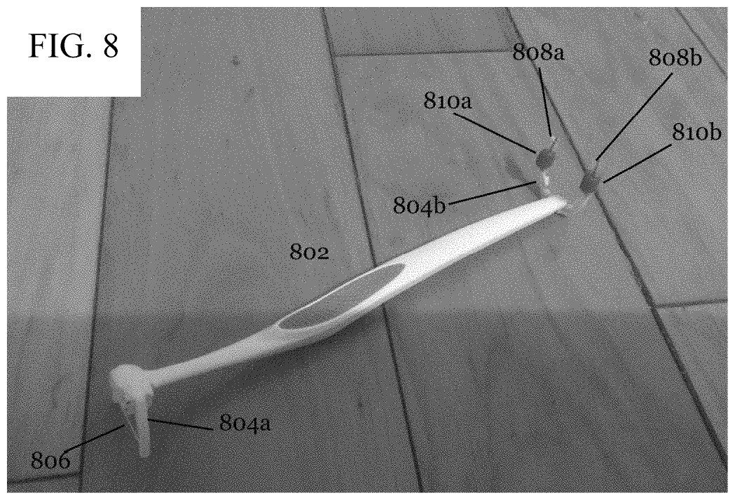

FIG. 8 depicts an eighth optional structure comprising snap-on flossers 804 on each end of the tool with a first snap-on flosser 804a not having implements. A second snap-on flosser 804b has a proxy brush 808a-b and a gum stimulator 810a-b on each end of the second snap-on flosser 804b in a structure similar to that depicted in FIG. 7.

The attachment depicted in FIG. 8 may be considered as an on-the-go appliance including floss, gum stimulator and proxy brush. To use these attachments, the user would 1) floss teeth with flosser end; and 2) flip it and slowly brush in into embrasure by massaging circular motion, thus removing bacteria, and stimulating blood flow simultaneously.

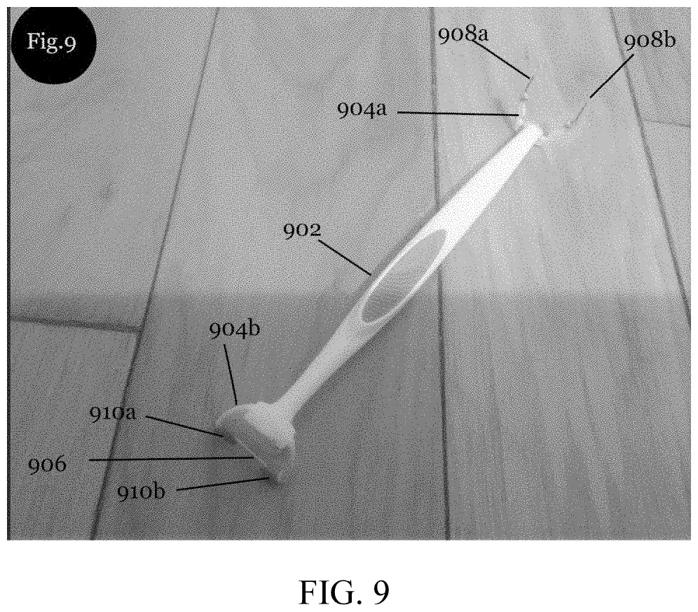

FIG. 9 depicts a ninth optional structure in which a first end of the tool hosts snap-on flosser 904a with brushes 908a-b positioned on separate ends of the flosser 904a in a parallel manner. A second end of the tool hosts snap-on flosser 904b with floss 906 and gum stimulators 910a-b positioned at ends of the flosser 904b parallel with the floss 906 and pointing toward each other.

The attachment depicted in FIG. 9 may also be regarded as an on-the-go type of appliance that ergonomic and useful for all patients. To use these attachments, a user would 1) use floss between all teeth and massage gums simultaneously with circular motions by using gum stimulators and rubbing slowly on each side; buccal and lingual; and 2) then flip device and use proxy brushes under crowns, bridges, and teeth with wide gaps.

Systems and methods provided herein may have the following advantages over previous implementations:

1) take less space

2) need less time to perform all daily hygiene instructions

3) more cost effective

4) eliminate switching one appliance with another

In an embodiment, a multiple purpose oral care device is provided. The device comprises a two-ended manual tool with ergonomically shaped handle and attachment components located at least at a first end to accommodate semi-circular snap-on flossers. The device also comprises disposable implements for dental and gum care that attach to the snap-on flossers and comprise optional structures. The disposable implements comprise at least one of brushes and gum stimulators and are situated at ends of the snap-on flossers. A first optional structure combines a snap-on flosser and two parallel inter-proximal brushes, one on each end of the flosser. The first optional structure is directed to orthodontic patients with braces and patients with fixed restorations comprising at least one of crowns and bridges. A second optional structure comprises two gum stimulators, one with each attached on opposite sides of the snap-on flosser, pointing inward to each other and parallel to floss. A third optional structure combines the snap-on flosser, proxy brushes, and gum stimulators, wherein each end of the snap-on flosser contains both a proxy brush and a gum stimulator. A fourth optional structure comprises two snap-on flossers on one end of the device and is directed to flossing between two upper and two lower teeth simultaneously. A fifth optional structure comprises a snap-on flosser without floss and two gum stimulators, one on each end of the flosser and pointing toward each other.

In another embodiment, a system for facilitating dental and gum care is provided. The system comprises an ergonomically shaped elongated handle with two ends, each end configured to accommodate a snap-on flosser with optional structure. The system also comprises a fitting at each end, each fitting configured to hold the snap-on flosser and optional structure. The system also comprises oral care implements comprising at least one of a brush and a gum stimulator for attachment to the flossers and comprising the optional structure. A sixth optional structure comprises two interproximal brushes per flosser, one each positioned on ends of a flosser and parallel to each other. A seventh optional structure comprises a proxy brush and a gum stimulator on each end of the snap-on flosser. The gum stimulator massages papillae and interdental brush cleans gum simultaneously.

In yet another embodiment, a double-ended oral hygiene device is provided comprising an elongated tool ergonomically configured for handheld use. The system also comprises a first end and a second end of the tool, each configured to accommodate at least one semicircular-shaped snap-on flosser. The system also comprises a plurality of disposable oral treatment implements, each removably attached to the at least one flosser in optional structures. The oral treatment implements comprise interdental brushes and gum stimulators. Optional structures comprise snap-on flossers and combinations of the implements. An eighth optional structure comprises snap-on flossers on each end of the tool with a first snap-on flosser not having implements and a second snap-on flosser having a proxy brush and a gum stimulator on each end of the second snap-on flosser. A ninth optional structure comprises a first snap-on flosser on the first end and a second snap on flosser on the second end. The first flosser comprises two gum stimulators, one each attached on opposite sides of the first flosser, pointing inward to each other and parallel to the floss, and the second flosser comprises two interproximal brushes, one each positioned on ends of the flosser and parallel to each other. The optional structures are directed to orthodontic patients with braces and patients with fixed restorations comprising at least one of crowns and bridges. The optional structures are directed to children, users with arthritis, users with other disabilities including poor hand-to-eye coordination, and handicapped users with lack of muscle control.

What is claimed:

1. A multiple purpose oral care device, comprising:
a two-ended manual tool with ergonomically shaped handle;
attachment components located at least at a first end to accommodate semi-circular snap-on flossers; and
disposable implements for dental and gum care that attach to the snap-on flossers and comprise optional structures.

2. The device of claim 1, wherein the disposable implements comprise at least one of brushes and gum stimulators and are situated at ends of the snap-on flossers.

3. The device of claim 1, wherein a first optional structure combines a snap-on flosser and two parallel inter-proximal brushes, one on each end of the flosser.

4. The device of claim 3, wherein the first optional structure is directed to orthodontic patients with braces and patients with fixed restorations comprising at least one of crowns and bridges.

5. The device of claim 1, wherein a second optional structure comprises two gum stimulators, one with each attached on opposite sides of the snap-on flosser, pointing inward to each other and parallel to floss.

6. The device of claim 1, wherein a third optional structure combines the snap-on flosser, proxy brushes, and gum stimulators, wherein each end of the snap-on flosser contains both a proxy brush and a gum stimulator.

7. The device of claim 1, wherein a fourth optional structure comprises two snap-on flossers on one end of the device and is directed to flossing between two upper and two lower teeth simultaneously.

8. The device of claim 1, wherein a fifth optional structure comprises a snap-on flosser without floss and two gum stimulators, one on each end of the flosser and pointing toward each other.

9. A system for facilitating dental and gum care, comprising:
an ergonomically shaped elongated handle with two ends, each end configured to accommodate a snap-on flosser with optional structure;
a fitting at each end, each fitting configured to hold the snap-on flosser and optional structure; and
oral care implements comprising at least one of a brush and a gum stimulator for attachment to the flossers and comprising the optional structure.

10. The system of claim 9, wherein a sixth optional structure comprises two interproximal brushes per flosser, one each positioned on ends of a flosser and parallel to each other.

11. The system of claim 9, wherein a seventh optional structure comprises a proxy brush and a gum stimulator on each end of the snap-on flosser.

12. The system of claim 11, wherein the gum stimulator massages papillae and interdental brush cleans gum simultaneously.

13. A double-ended oral hygiene device, comprising:
an elongated tool ergonomically configured for handheld use;
a first end and a second end of the tool, each configured to accommodate at least one semicircular-shaped snap-on flosser; and
a plurality of disposable oral treatment implements, each removably attached to the at least one flosser in optional structures.

14. The device of claim 13, wherein the oral treatment implements comprise interdental brushes and gum stimulators.

15. The device of claim 13, wherein optional structures comprise snap-on flossers and combinations of the implements.

16. The device of claim 13, wherein an eighth optional structure comprises snap-on flossers on each end of the tool with a first snap-on flosser not having implements and a second snap-on flosser having a proxy brush and a gum stimulator on each end of the second snap-on flosser.

17. The device of claim 13, wherein a ninth optional structure comprises a first snap-on flosser on the first end and a second snap on flosser on the second end.

18. The device of claim 17, wherein the first flosser comprises two gum stimulators, one each attached on opposite sides of the first flosser, pointing inward to each other and parallel to the floss, and the second flosser comprises two interproximal brushes, one each positioned on ends of the flosser and parallel to each other.

19. The device of claim 13, wherein the optional structures are directed to orthodontic patients with braces and patients with fixed restorations comprising at least one of crowns and bridges.

20. The device of claim 13, wherein the optional structures are directed to children, users with arthritis, users with other disabilities including poor hand-to-eye coordination, and handicapped users with lack of muscle control.
